(19) United States
(12) Patent Application Publication
(10) Pub. No.: US 2006/0100918 A1
(43) Pub. Date: May 11, 2006

(54) MODELING OPERATING EFFICIENCY BASED ON RATES OF UNRESOLVED PROBLEMS

(75) Inventors: Barbara Macy, Charlotte, NC (US); Aline Young, Charlotte, NC (US); Kenneth R. Dafforn, Charlotte, NC (US)

Correspondence Address: MOORE & VAN ALLEN PLLC, P.O. BOX 13706, Research Triangle Park, NC, 27709, US

(73) Assignee: BANK OF AMERICA CORPORATION, Charlotte, NC (US)

(21) Appl. No.: 10/908,925

(22) Filed: Jun. 1, 2005

Related U.S. Application Data
(60) Provisional application No. 60/522,817, filed on Nov. 10, 2004.

(51) Int. Cl. G07G 1/00; G06F 17/30

(52) U.S. Cl. 705/10

(57) ABSTRACT

Modeling operating efficiency based on rates of unresolved problems. Embodiments of the present invention describe a tool that model operating efficiency be examining the impact of unresolved problems in an enterprise. An inventory of unresolved problems is determined based on at least some of, a beginning inventory of problems, an incoming rate of problems, and the total resolution rate for the problems. An event volume can also be added to account for unusual activity. A tool according to embodiments of the invention can then determine and display the primary unresolved rate of problems. In some embodiments, a complexity distribution based on historical data indicating the length of time taken to solve various problems in the enterprise can also be displayed.

### CROSS-REFERENCE TO RELATED APPLICATIONS

This application claims priority from co-pending provisional patent application Ser. No. 60/522,817 filed Nov. 10, 2004, the entire disclosure of which is incorporated herein by reference.

Much of what is disclosed in this application is also disclosed in co-pending, commonly owned application Ser. No. 10/905,254, filed Dec. 22, 2004, the entire disclosure of which is incorporated herein by reference.

### CROSS-REFERENCE TO COMPUTER PROGRAM LISTING APPENDIX

A portion of the present disclosure is contained in a computer program listing appendix. The appendix contains an MS-DOS file entitled URIM.txt created on Mar. 24, 2005, of approximately 18 kilobytes. The contents of this file are incorporated herein by reference. Any references to “the appendix” or the like in this specification refer to this file.

The contents of this file are subject to copyright protection. The copyright owner has no objection to the reproduction by anyone of the patent document or the appendix as it appears in the Patent and Trademark Office patent files or records, but does not waive any other copyright rights by virtue of this patent application.

### BACKGROUND

Understanding how to execute a business process within a company or enterprise in order to maximize revenue, profit, or other metrics, is of enormous importance and has a significant impact on the company's success in the marketplace. Ideally therefore, business processes should be monitored, modeled, and optimized in much the same ways as scientific or manufacturing processes. Thus, the same management tools and methodologies as typically applied to manufacturing processes, for example six sigma and “lean” management techniques, can and should be applied to business processes.

Six sigma is a rigorous and disciplined methodology that uses data and statistical or statistics-like analysis to improve operational performance. The term “sigma” refers a statistical expression of numbers defects per numbers opportunities, with “six sigma” corresponding to 3.4 defects per million. “Lean” is a term used to refer to techniques originally developed in the automobile industry to improve manufacturing performance. Lean and six sigma methodologies can be applied together.

When a business process is being analyzed using either a six sigma or a lean technique (or both) the faster the analysis can be accomplished with accuracy, the sooner the enterprise can reap the benefits. Thus, tools and methods to make the six sigma, lean, or other process being used to improve or operationalize excellence of the business process can be important.

### SUMMARY

Embodiments of the present invention describe a tool that can help facilitate an expedited six sigma and/or lean methodology. Such a methodology may be referred to herein as “turbolean” and can be used to operationalize business process excellence. The turbolean method includes characterizing current or “as-is” business processes and developing, characterizing, and evaluating “to-be” business processes in a continuous improvement loop. The tool of the present invention can facilitate the evaluation of operating efficiency by facilitating the examination of rates of unresolved problems in a business or enterprise.

In example embodiments of the invention, operating efficiency can be modeled with the aid of a tool that helps determine the impact of unresolved problems in an enterprise. The tool first determines a total resolution rate for problems. An inventory of unresolved problems is calculated based on at least some of, a beginning inventory of problems, an incoming rate of problems, and the total resolution rate for the problems. An event volume can also be added to account for unusual activity. A tool according to embodiments of the invention can then display the primary unresolved rate of problems, at least in part by dividing the inventory of problems by the product of the incoming rate of problems and a pre-selected time period.

In some embodiments, the total resolution rate of problems can be determined by establishing a plurality of skill levels for associates (employees or contractors) where each skill level covers a number of associates. For each skill level, the average capability for the skill level is multiplied by the number of associates to obtain a plurality of problem resolution rates. All of the problem resolution rates are added together to produce the total resolution rate. In some embodiments, the tool can also display a complexity distribution based on historical data indicating the length of time taken to solve various problems in order to further characterize the skill levels and nature of the problems being addressed.

In some embodiments, the invention is implemented via either a stand-alone instruction execution platform or such a platform interconnected with other platforms or data stores by a network, such as a corporate intranet, a local area network, or the Internet. A computer program product or computer program products contain computer programs with various instructions to cause the hardware to carry out, at least in part, the methods and processes of the invention. Data stores can include inputs developed through team activities, as well as takt and production outputs for use in further efforts at operationalizing process excellence relative to the business process or processes at issue.

### BRIEF DESCRIPTION OF THE DRAWINGS

FIG. 1 is a block diagram of an overall system that promotes business excellence, in part through operationalizing process excellence.

FIG. 2 is a flowchart that illustrates a portion of a method of using lean tools according to embodiments of the invention to operationalize process excellence.

FIG. 3 is a screenshot of an input/output screen for the unresolved rate impact model (URIM) tool according to example embodiments of the invention.

FIG. 4 is a flowchart that illustrates the operation of the URIM tool according to example embodiments of the invention.

FIG. 5 is a “swim lanes” diagram that shows an example process to which the modeling technique of embodiments of the invention can be applied.

FIG. 6 is a system block diagram according to example embodiments of the invention.

### DETAILED DESCRIPTION

The present invention will now be described in terms of specific, example embodiments. It is to be understood that the invention is not limited to the example embodiments disclosed. It should also be understood that not every feature of the systems and methods described is necessary to implement the invention as claimed in any particular one of the appended claims. Various elements, steps, processes, and features of various embodiments of systems, apparatus, and processes are described in order to fully enable the invention. It should also be understood that throughout this disclosure, where a process or method is shown or described, the steps of the method may be performed in any order or simultaneously, unless it is clear from the context that one step depends on another being performed first. Also, time lags between steps can vary.

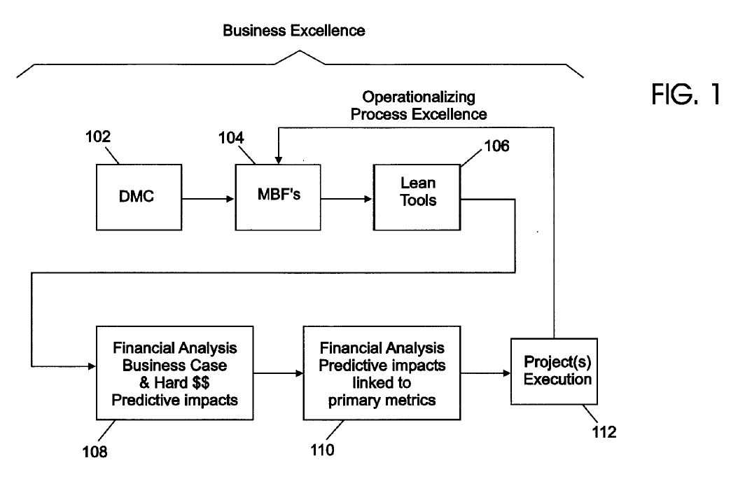

FIG. 1 illustrates the operating environment of the invention as a system of related activities represented by system blocks. These activities can be carried out to some extent in parallel and there may be overlap between the activities. The system can be used to enable or operationalize process excellence and may include varying numbers of tools as a part of the process. Portions of the process may be referred to herein as “turbolean.” Turbolean can be a 30 to 90 day execution methodology that melds process excellence with six sigma tools and lean tools (which together may be referred to herein as “lean” tools), and may include activity-based financial tools along with an operational efficiency model, to create a continuous improvement productivity loop. The example system of FIG. 1 includes define, measure, and control (DMC) activities 102, and management by fact activities (MBF's) 104.

In block 106 of FIG. 1, lean tools, and possibly other tools are used to produce financial analysis including a business case and hard-cost-related, predictive impacts, as shown at block 108. Subsequently, a financial analysis that includes predictive impacts linked to primary metrics is produced at block 110. Project execution 112 can then be undertaken, which is managed by fact at block 104. This implementation and control can produce a feedback loop that operationalizes process excellence, within an overall system of business excellence system.

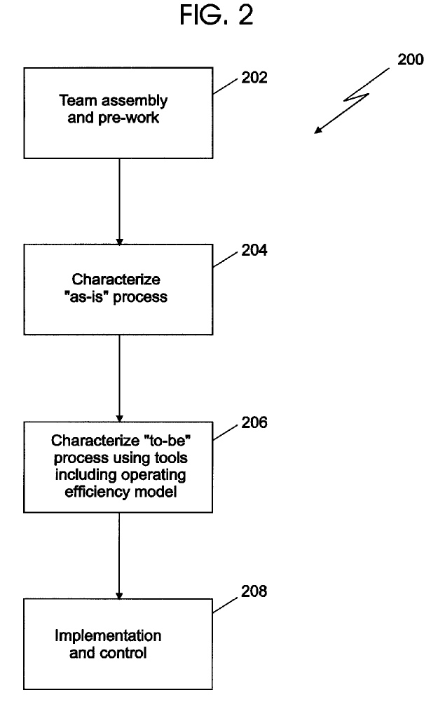

FIG. 2 describes how the tools used in the system of FIG. 1 are applied to produce the financial analysis and implement process improvement. As opposed to the system view of FIG. 1, FIG. 2 is a process view presented in flowchart form, as a series of process blocks. Process 200 of FIG. 2 includes team assembly and pre-work as shown at block 202. Pre-work sessions in some embodiments are those in which products' or services' evolution can be examined and opportunities to reduce completion time, improve delivery time to customers and reduce overall costs can be identified. Tools can be used to characterize an end-to-end flow of the product through the business process. These tools can include kick-off information meeting materials and team member lists. A kick-off meeting can provide an open forum to address questions to the members with respect to the process early so the members are more productive during the team sessions. A performance plan can be developed that incorporates current and future processes and a recommended timeline for tracking the project. The tools used early in pre-work call sessions can include an assessment tool and a performance plan tool, for example, as well as Hoshin planning or other closed-loop performance plan tools to provide a baseline and a progression check of metrics for initiatives. A lean work plan and the member contact list can also be used in the pre-work sessions to document the project tasks, the lean team member(s) assigned a particular task, and task start and completion dates.

In the example of FIG. 2, the as-is process can be characterized at block 204 by determining the impact of changes on the process and on employee views through developing an as-is process map, including a time vs. waste view of the business process. Additional tools used can include a management plan, skills matrix, a voice-of-the-associate (VOA) or employee opinion survey, and a work plan. The work plan can help identify the stakeholders, their reaction to the changes and potential risks. The skills matrix identifies the strengths and weaknesses of team members by ascertaining the gaps to skills needed to complete the project.

A multi-generational plan can be established. The first generation of the plan can set out tasks for vision, process generations, technologies, scope, governance and metrics for tracking project success. The first generation plan can also set out a generation task timeline. To determine the voice-of-the associate, a survey can be prepared to determine what works, what doesn't work, what should be changed, and a positive and a negative that would impact the product or service or the use of it.

Process maps can be created to assist in characterizing the as-is process. Data can be collected from on-site interviews of the associates (employees) and directly used to build an overall as-is process map and other types of process maps. A spaghetti map can also be constructed that illustrates the environment of the as-is process. Additionally, causes and effects can be analyzed and described as part of the as-is process using such tools as a cause-and-effect fishbone diagram and a cause-and-effect matrix built from the fishbone. Additionally, waste can be described and characterized, and quantified based on observed timings and Muda costing.

An additional tool that can be used early in team sessions at block 204 of FIG. 2 is the “cost-of-poor-process-opportunity” (COPPO) tool, which captures and identifies the cost per process step. In example embodiments, this tool can be implemented with a Microsoft Excel™ spreadsheet running a visual basic macro. The same type of spreadsheet can be used later to identify future COPPO or the COPPO in the “to-be” process. Source code for visual basic macros to provide a COPPO spreadsheet for both the as-is and to-be processes in tabs (along with other tools) is contained in the appendix and is listed last.

Later, possibly in team sessions, the to-be process can be characterized as shown at block 206 of FIG. 2. Various tools such as a project prioritization by risk/reward and a baseline tree metric can be used along with process flows, some of which are updated from the analysis of the as-is process. For example, the VOA can be used, as well as an activity of the product analysis, an activity of the associate analysis, and an activity of the equipment analysis. Such analysis tools can include a process flows and time value maps. The activity of the equipment (AOE) analysis can include determining operating equipment efficiency and developing an associated efficiency log, and an AOE spaghetti map. One tool that can be used to determine a future or to-be state is an analysis to identify, and then convert or eliminate (ICE) waste. Sources of waste are analyzed, and financial analysis can be performed. A takt time calculator, which can also be referred to as a takt-o-meter or takt-o-meter tool, can be used to determine the pace of production needed to produce a unit to meet customer demand requirements at a level necessary to drive the to-be state or optimize the as-is state. Source code for an example embodiment of the takt-o-meter is listed in the appendix as the second block of code.

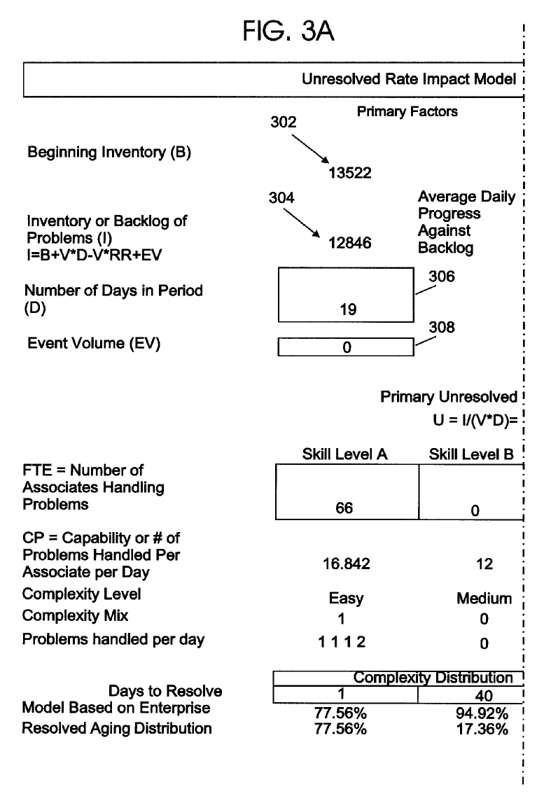

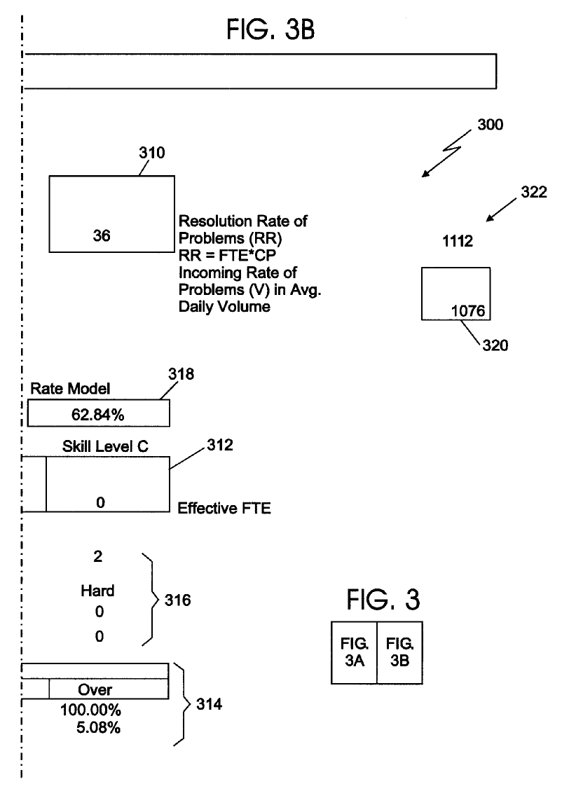

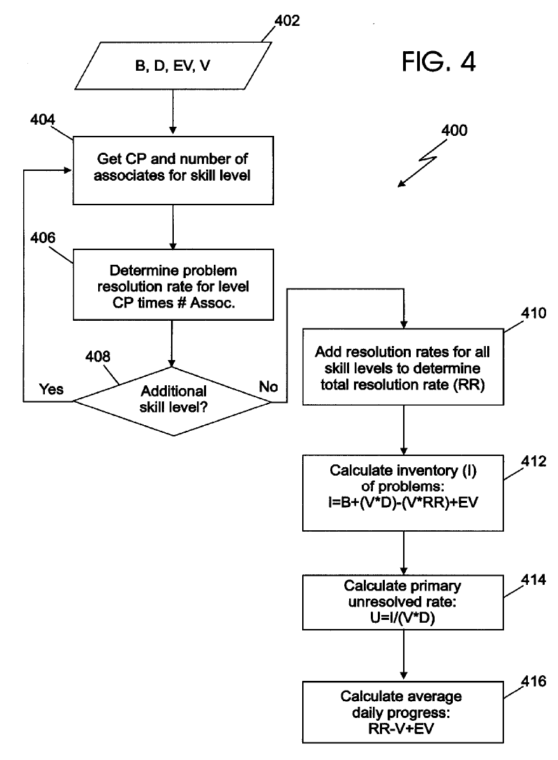

In the operating environment of the invention, as described by FIGS. 1 and 2, a new process design and product flow can be delineated, along with any exception flows necessitated. Standard work is described so that an associate can be trained. Strategies and assessments can be completed, and can include monument identification, and a so-called “5S” assessment, which focuses on workplace layout and cleanliness. In addition, as part of the to-be process characterization of FIG. 2, an operating efficiency analysis is done through an operating efficiency model providing complexity and skill level scenarios for various staffing and inventory levels against a primary metric that is variable by engagement. One example of the operating efficiency model is implemented via a spreadsheet running a visual basic script. Example visual basic source code is included in the appendix, and an example operating efficiency model is described in the remaining portions of this description with reference to FIGS. 3 and 4.

Material inputs for the business process can be identified along with an internal replenishment plan or “Kanban” strategy. Perishable supplies can also be described and supported with Kanban calculations. Cost analysis can be performed for the to-be process, and a business case proof of concept tool can be used to identify cost-per-step in the to-be process compared to costs in the former as-is process, the savings opportunity, and the initiatives needed to capture the opportunity in the new process. Another tool, a critical-to-business results analysis can be used to compare the business value determined for each initiative coming out of the to-be process against its ease of implementation. The business case proof of concept tool can be implemented as a spreadsheet running a visual basic script. An example visual basic source code listing for a multi-tabbed spreadsheet file that includes as-is and to-be COPPO tool worksheets as well as an example business case proof of concept tool worksheet. An operational risk assessment can be done to assess potential risk for the proposed initiatives.

As shown at block 208 of FIG. 2, a deployment/implementation and control plan can be created and executed after the as-is and to-be processes or “states” have been characterized and analyzed. Final metrics are defined and linked to the initiatives being piloted. A final operating efficiency matrix can also be used to model pilot results. A plan for visually displaying and updating these metrics is also put in place. New roles and responsibilities are defined, standard work definitions are developed and a scheduling system can be refined and/or created. A final or additional to-be takt and staffing calculation can be performed and institutionalized. Typically, ongoing training and support plans are also put in place. As part of the control plan, the multi-generational plan previously discussed can be updated or created. In addition a “Kaizen” strategy, audit routine, and workflow policies and procedures can be created and implemented. After the above is completed the new process is fully implemented and results including lessons learned are captured. A plan can then be put in place to transition to a new process, possibly including new or newly certified personnel.

FIG. 3 is an example screen shot of a user screen, 300, for a software implementation of the operating efficiency model tool discussed above according to example embodiment of the invention. This tool is designed to provide an operational efficiency model based on unresolved rate impact to work on any problem in a transaction-oriented production environment. In this example embodiment, the tool is implemented by a visual basic script running within a version of Microsoft Excel™. The primary metric in this embodiment is the unresolved rate. Field 302 is a beginning inventory (B), which represents the amount of work that exists in the time period being considered. This field may be populated by the user when the tool is being run, or may be pulled from a data store. The example shows 13,522 cases, which is the number problems that exist in a particular area on a particular day that modeling is to begin. Field 304 of FIG. 3 represents the ending inventory, backlog (I) or the outcome at the end of the model period, i.e. after the model simulation has been run. This field is typically calculated. An example formula is shown in screen 300 to the left of field 304 and the calculation with be discussed in more detail with respect to the flowchart of FIG. 4.

Still referring to FIG. 3, field 306 is the number of days in the pre-selected time period being modeled. In many cases a time period of a month is chosen and in most months in businesses that operate on a 5-day work week the number of workdays available is between 19 and 22, with exceptions between 18 and 23 workdays. For this example 19 days has been input by a user.

Field 308 of FIG. 3 is an input called “event volume” that can be used to represent any kind of unusual activity that brings additional inventory or additional work into the process. For example, if a sales pitch might offer a special to a market so that another 1,000 work items came in at once or in a relatively short period of time, the number 1,000 would be entered. This would increase the beginning inventory and also increase the amount of work that needs to be done in that month to reach equilibrium. In many cases the event volume is zero, so zero is used in the example of FIG. 3.

Field 310 of FIG. 3 is another calculated item. The calculation will again be discussed with respect to FIG. 4. An equilibrium state is reached when an organization is working every period so that it's progressing to produce in output the same number of items or problems as received in input. For instance if 500 transactions are received in a day and 500 were processed, a state of equilibrium would exist because the input would equal output. If only 400 items were processed, and 500 items were input, there would be a negative progress against backlog, and inventory would grow by 100 transactions a day. Field 310 in this example (as can be appreciated from the code in the appendix) is conditionally formatted to turn red if progress is not being made. In the particular example, it shows 36 cases of progress against the backlog in a day. Backlog is being decreased at the rate of 36 items per day. If work continued at this same rate, the inventory would slowly dwindle down to zero.

Still referring to FIG. 3, fields 312 represent skill levels of associates (employees) available to handle work items in the enterprise. In this example, three skill levels are delineated “A”, “B”, and “C”, representing average skill levels for the employees in each group as determined by the supervisors or managers managing the group working the process. This is an example only, and the tool can be changed to accommodate any number of skill levels, or only one. The input for these fields is a number of effective full time employees (FTE's) and may be supplied by the user or pulled from a data store. A skills assessment or another type of performance assessment can be used to make this determination. This feature can help determine which kind of resources to apply to which problems or cases coming into the workflow process. For example, if people with the greatest skill perform the easiest tasks, and people with the lowest level of skill perform the hardest tasks, a larger backlog of problems or cases to resolve can result. In a typical use of the tool, the employees assigned to the tasks can be scaled based on the complexity distribution fields, 314, shown near the bottom of screen 300 and discussed below. This can be accomplished manually, or the tool could be enhanced to make recommendations based on the complexity distribution. Complexity distribution fields 314 in this example distribute problems into three groups based on “Days to Resolve” which are input by the user. The “Model Based on Enterprise” line is a cumulative distribution, in this example showing the percentage of problems solved or items handled in one day or less, 40 days or less, and over 40 days (or less). The “Resolved Aging Distribution” line is a non-cumulative distribution showing the number of problems in each category. These numbers can be calculated in the standard way based on stored data for each problem (date in vs. date out) or can be input manually.

Complexity level fields 316 combine the capability (CP=average number of problems handled per day per associate) for associates in each skill level with the actual number of associates to determine the problems handled per day, or the problem resolution rate for a given skill level. Combining the numbers of problems being assigned to each skill level with the capability for the skill level can also aid in determining the length of time to put in the “Days to Resolve” fields for the complexity distribution. In this particular example, although only associates in the lower skill level are available, it has been learned that easy problems are solved in one day or less, harder problems, needing extra research, can take up to 40 days, and the hardest problems can take longer. The medium problems represented over 17% of the workload in this example. The very complex problems represent over 5% of this workload. This distribution can indicate how to allocate the employees available, and also what kinds of skills are needed.

Still referring to FIG. 3, filed 318 displays the calculated, “unresolved rate of problems” primary metric. This metric in this example is essentially the inventory or backlog of problems divided by the volume of cases multiplied by the number of days' volume. Other equations could be used to compute the volume in this field. In this particular example, the primary metric is 62.84%, and this metric reflects process capability because it shows how the outstanding rate (output) compares to the incoming rate (input). A change in capacity would normally cause this metric to change.

Field 320 of FIG. 3 displays the incoming rate of problems (V) occurring on a daily basis. The rate of resolution (RR) shown in field 322 is the rate that problems are actually handled during a particular period of time with the skilled set of labor that is available. In this example 1,112 cases per day are being resolved. This average value is a computed by summing the problem resolution rates for each skill level. In this case, since the resolution rates for two of the skill levels is zero, the total resolution rate is the same as the resolution rate for associates in skill level “A.” If 1,112 cases are being resolved daily, and the incoming rate is 1,076, the difference between these two values is 36, indicating the progress per day that is reducing inventory or backlog, as shown in field 310, previously discussed. This is a daily factor.

FIG. 4 illustrates an example process, 400, for an example unresolved rate impact model tool according to an example embodiment of the invention like that shown in FIG. 3. FIG. 4 is a flowchart illustration. As is typical with a flowchart illustration, sub-processes, elements, or steps are illustrated as a series of process blocks. Block 402 represents the input, in this example, the beginning inventor (B), the number of days in the time period (D), the event volume (EV) and the average daily rate of incoming problems (V). At blocks 404 and 406, the average capability of the employees in each skill level and the number of employees are retrieved (either from a data store or from user input) and multiplied to obtain the problem resolution rate for each skill level. Once these calculations are complete at block 408, the resolution rates for all skill levels are added together at block 410 to obtain a total resolution rate (RR) for problems given the resources available.

Still referring to FIG. 4, the inventory or backlog (I) of problems is calculated at block 412 using the formula shown. The primary unresolved rate metric is calculated at block 414 and the average daily progress is calculated at block 416, as previously discussed. Note that the complexity distribution calculations are not shown in FIG. 4 for clarity; however, these calculations take place in parallel with the calculations shown and simply use in and out dates for problems solved in the enterprise.

The first block of source code listed in the source code appendix is visual basic source for operating efficiency modeling using an unresolved rate impact model according to an example embodiment of the invention. The input screen generated by this code is similar to what was illustrated in FIG. 3 and discussed with respect thereto. It should be noted that this code is conceptual in nature, and the embodiment here may not necessarily match all aspects of the embodiment shown in FIGS. 3 and 4.

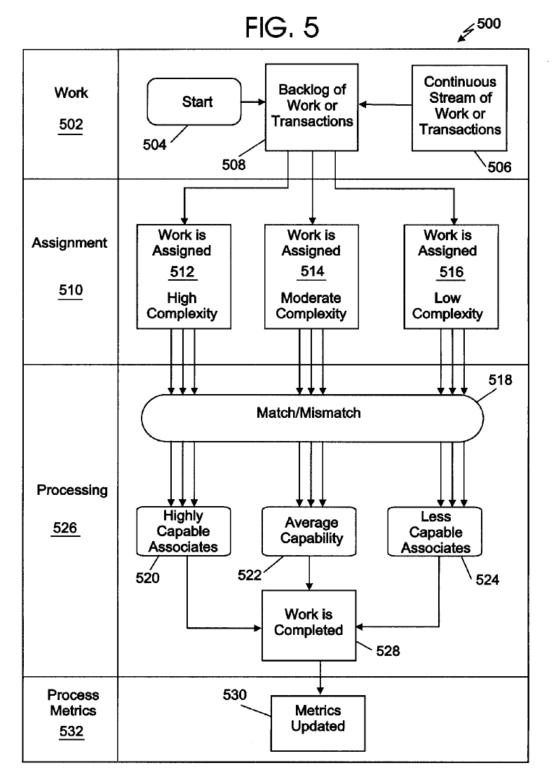

FIG. 5 is an example process map that illustrates the type of process to which an example tool like that discussed relative to FIGS. 3 and 4 can be applied. Process map 500 is presented as a so-called “swim lanes” diagram, a type of diagram that is known in the quality management arts. Work processes are presented in swim lanes of horizontal groups of process steps. Work swim lane 502 is where the process starts at block 504, with a continuous stream of work 506 entering the backlog of work or transactions, shown as block 508. In assignment swim lane 510, work is broken up into different levels of complexity: highly complex work is assigned in block 512, moderately complex work is assigned in block 514, and work of low complexity is assigned in block 516. Problems are sorted by complexity so that they can be allocated to appropriate personnel. From each process block, three lines emerge into block 518, which represents how work is matched to associates. Three lines then emerge into each of, block 520 representing highly capable associates, block 522 representing average capability associates, and block 524 representing less capable associates, all in processing swim lane 526. Although ideally, work is matched based on the skill level of associates, in a typical enterprise there will be some level of mismatch. For example, a highly complex problem may go in some cases to an average capability person or a low capability person. Each skill level individual has some level of “wrong” transactions coming to them. So highly capable, average capable, and less capable individuals will all be assigned transactions at all levels. The number of transactions that are mismatched in a scenario like that described above can vary greatly. Some misalignment may be due to a defect in the process. As a result, capacity to handle the complex problems may be lacking.

Still referring to FIG. 5, work is completed at block 528 in processing swim lane 526. There would typically be various rates of completion, but normally, the completion rate for highly complex work would be lower than the completion rate for low complexity work. Once work is completed (or at any point in the process) the metrics can be updated at block 530 in swim lane 532.

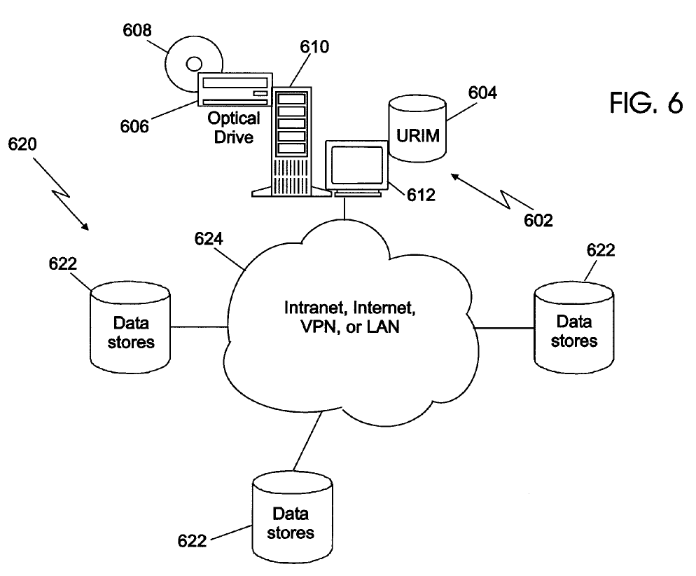

FIG. 6 illustrates a typical operating environment for embodiments of the present invention. FIG. 6 actually illustrates two alternative embodiments of a system implementing the invention. System 602 can be a workstation or personal computer. System 602 can be operated in a “stand-alone” mode. The system includes a fixed storage medium, illustrated graphically at 604, for storing programs and/or macros which enable the use of an embodiment of the invention. In a stand-alone implementation of the invention, fixed storage 604 can also include saved output data, such as unresolved rate results and complexity distributions, and saved input data such as problem inventory information. In this particular example, an optical drive, 606, is connected to the computing platform for loading the appropriate computer program product into system 602 from an optical disk, 608. The computer program product includes a computer program or programs with instructions or code for carrying out the methods of the invention. Instruction execution platform 610 of FIG. 6 can execute the appropriate instructions and display appropriate screens on display device 612. These screens can include the user input screen previously discussed.

FIG. 6 also illustrates another embodiment of the invention in which case the system 620, which is implementing the invention, includes a connection to data stores 622, from which data on problem resolution times, backlogs, and the like can be read, and to which output data such as results can be saved for future reference. The connection to the data stores or appropriate databases can be formed in part by network 624, which can be an intranet, virtual private network (VPN) connection, local area network (LAN) connection, or any other type of network resources, including the Internet.

A computer program which implements all or parts of the invention through the use of systems like those illustrated in FIG. 6 can take the form of a computer program product residing on a computer usable or computer readable storage medium. Such a computer program can be an entire application to perform all of the tasks necessary to carry out the invention, or it can be a macro or plug-in which works with an existing general purpose application such as a spreadsheet or database program. Note that the “medium” may also be a stream of information being retrieved when a processing platform or execution system downloads the computer program instructions through the Internet or any other type of network. Computer program instructions which implement the invention can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

Specific embodiments of an invention are described herein. One of ordinary skill in the computing and process management arts will recognize that the invention can be applied in other environments and in other ways. It should also be understood that an implementation of the invention can include features and elements or steps in addition to those described and claimed herein. Thus, the following claims are not intended to limit the scope of the invention to the specific embodiments described herein.

What is claimed is:

1. A method of modeling operating efficiency based on a primary unresolved rate of problems, the method comprising:
determining a total resolution rate for problems;
calculating an inventory of problems based on at least some of, a beginning inventory, an incoming rate of problems, and the total resolution rate; and
displaying the primary unresolved rate of problems, at least in part by dividing the inventory of problems by the product of the incoming rate of problems and a pre-selected time period.

2. The method of claim 1 wherein the determining of the total resolution rate for problems further comprises:
establishing a plurality of skill levels for associates, each skill level having a number of associates associated therewith;
for each skill level, multiplying the average capability for the skill level by the number of associates to obtain a plurality of problem resolution rates, one for each skill level; and
adding together the plurality of problem resolution rates to produce the total resolution rate.

3. The method of claim 2 wherein the calculating the inventory of problems is also based at least in part on an event volume.

4. The method of claim 1 further comprising displaying a complexity distribution based on historical data indicating a length of time taken to solve each of a plurality of problems.

5. The method of claim 2 further comprising displaying a complexity distribution based on historical data indicating a length of time taken to solve each of a plurality of problems.

6. The method of claim 3 further comprising displaying a complexity distribution based on historical data indicating a length of time taken to solve each of a plurality of problems.

7. A computer program product for modeling operating efficiency based on a primary unresolved rate of problems, the computer program product including computer program code comprising:
instructions for determining a total resolution rate for problems;
instructions for calculating an inventory of problems based on a beginning inventory, an incoming rate of problems, and the total resolution rate; and
instructions for displaying the primary unresolved rate of problems, at least in part by dividing the inventory of problems by the product of the incoming rate of problems and a pre-selected time period.

8. The computer program product of claim 7 wherein the instructions for determining the total resolution rate for problems further comprise:
instructions for establishing a plurality of skill levels for associates, a skill level having a number of associates associated therewith;
instructions for obtaining a plurality of problem resolution rates, one for each skill level; and
instructions for adding together the plurality of problem resolution rates to produce the total resolution rate.

9. The computer program product of claim 8 wherein the inventory of problems is also based at least in part on an event volume.

10. The computer program product of claim 7 further comprising instructions for displaying a complexity distribution based on historical data indicating a length of time taken to solve each of a plurality of problems.

11. The computer program product of claim 8 further comprising instructions for displaying a complexity distribution based on historical data indicating a length of time taken to solve each of a plurality of problems.

12. The computer program product of claim 9 further comprising instructions for displaying a complexity distribution based on historical data indicating a length of time taken to solve each of a plurality of problems.

13. Apparatus for modeling operating efficiency based on a primary unresolved rate of problems, the apparatus comprising:
means for determining a total resolution rate for problems;
means for calculating an inventory of problems based on a beginning inventory, an incoming rate of problems, and the total resolution rate; and
means for displaying the primary unresolved rate of problems, at least in part by dividing the inventory of problems by the product of the incoming rate of problems and a pre-selected time period.

14. The apparatus of claim 13 wherein the inventory of problems is also based at least in part on an event volume.

15. The apparatus of claim 13 further comprising means for displaying a complexity distribution based on historical data indicating a length of time taken to solve each of a plurality of problems.

16. The apparatus of claim 14 further comprising means for displaying a complexity distribution based on historical data indicating a length of time taken to solve each of a plurality of problems.

17. A system for modeling operating efficiency based on a primary unresolved rate of problems, the system comprising:
an instruction execution platform operable to determining a total resolution rate for problems, calculate an inventory of problems based on at least some of, a beginning inventory, an incoming rate of problems, and the total resolution rate, and display the primary unresolved rate of problems, at least in part by dividing the inventory of problems by the product of the incoming rate of problems and a pre-selected time period; and
a data store operatively connected to the instruction execution system to supply at least one of the beginning inventory, the incoming rate of problems, and the total resolution rate.

18. The system of claim 17 wherein the instruction execution system is further operable to determine the total resolution rate for problems by a method further comprising:
establishing a plurality of skill levels for associates, each skill level having a number of associates associated therewith;
for each skill level, multiplying the average capability for the skill level by the number of associates to obtain a plurality of problem resolution rates, one for each skill level; and
adding together the plurality of problem resolution rates to produce the total resolution rate.

19. The system of claim 17 wherein:
the instruction execution system is further operable to display a complexity distribution based on historical data indicating a length of time taken to solve each of a plurality of problems; and
the data store is further operable to supply the historical data.

20. The system of claim 18 wherein:
the instruction execution system is further operable to display a complexity distribution based on historical data indicating a length of time taken to solve each of a plurality of problems; and
the data store is further operable to supply the historical data.
